(19) United States
(12) Patent Application Publication
(10) Pub. No.: US 2025/0119195 A1
(43) Pub. Date: Apr. 10, 2025

(54) WIRELESS SIGNAL TRANSCEIVER DEVICE, AND WIRELESS SIGNAL PROCESSING METHOD BASED ON PHYSIOLOGICAL STATE DETECTION

(71) Applicant: REALTEK SEMICONDUCTOR CORP., Hsinchu (TW)

(72) Inventors: Shau-Yu Cheng, Hsinchu (TW); Cheng-Jung Wu, Hsinchu (TW); Yi-Ru Lai, Hsinchu (TW)

(73) Assignee: REALTEK SEMICONDUCTOR CORP., Hsinchu (TW)

(21) Appl. No.: 18/902,026

(22) Filed: Sep. 30, 2024

(30) Foreign Application Priority Data
Oct. 4, 2023 (TW) 112138168

(51) Int. Cl. H04B 7/06; H04L 5/00

(52) U.S. Cl. CPC H04B 7/0626; H04L 5/0005

(57) ABSTRACT

A wireless signal transceiver device includes a receiver unit, a conversion module, an estimation module, a processing unit, and a storage unit. The receiver unit is configured to receive a wireless signal. The conversion module is electrically connected to the receiver unit and configured to convert the wireless signal into a frequency-domain signal. The estimation module is electrically connected to the conversion module and configured to estimate the frequency-domain signal so as to obtain first channel state information. The first channel state information includes a plurality of channel state information sub portions. The processing unit is electrically connected to the estimation module and configured to filter the first channel state information so as to obtain second channel state information. The storage unit is electrically connected to the processing unit and configured to store the second channel state information.

### CROSS-REFERENCE TO RELATED APPLICATION

This non-provisional application claims priority under 35 U.S.C. § 119(a) to Patent Application No. 112138168 filed in Taiwan, R.O.C. on Oct. 4, 2023, the entire contents of which are hereby incorporated by reference.

### BACKGROUND

### Technical Field

The instant disclosure is related to fields relevant to wireless communication, especially a wireless signal transceiver device and a wireless signal processing method based on physiological status monitoring.

### Related Art

In the process of a wireless signal being transmitted and then received, human bodies or items in the environment all contribute to influences such as reflection, penetration and scattering of the wireless signal. As a result, the wireless signal is transmitted to a receiving end through multiple paths. After a receiving end receives the wireless signal, the system will perform channel estimation on the wireless signal so as to obtain channel state information (CSI). The system is able to estimate the paths and states which the wireless signal underwent during the transmission according to the channel state information.

In general, the receiving end fully receives all wireless signals from different paths. As a result, too much unnecessary information is carried by the channel state information in the wireless signals. Consequently, during subsequent application of the channel state information, incorrect channel state information may be more easily captured, and thus an accuracy of information capturing is lowered.

### SUMMARY

In view of the above issues, a wireless signal transceiver device is provided. In an embodiment, the wireless signal transceiver device includes a receiver unit, a conversion module, an estimation module, a processing unit, and a storage unit. The receiver unit is configured to receive a wireless signal. The conversion module is electrically connected to the receiver unit. The conversion module is configured to convert the wireless signal into a frequency-domain signal. The estimation module is electrically connected to the conversion module. The estimation module is configured to estimate the frequency-domain signal so as to obtain first channel state information. The first channel state information includes a plurality of channel state information sub portions. The processing unit is electrically connected to the estimation module. The processing unit is configured to filter the first channel state information so as to obtain second channel state information. The storage unit is electrically connected to the processing unit, and the storage unit is configured to store the second channel state information.

In an embodiment, the processing unit filters out the channel state information sub portions which are outside a time interval from the first channel state information so as to obtain the second channel state information.

In an embodiment, the processing unit obtains equivalent frequency-domain information based on time-domain information of the time interval and then filters out the channel state information sub portions which are outside the time interval from the first channel state information according to the equivalent frequency-domain information.

In addition, a wireless signal processing method based on physiological status monitoring is provided. In an embodiment, the wireless signal processing method is executed by a processing circuit. The wireless signal processing method includes: converting a wireless signal which is received by a receiver unit into a frequency-domain signal; estimating the frequency-domain signal so as to obtain first channel state information, wherein the first channel state information includes a plurality of channel state information sub portions; and filtering the first channel state information so as to obtain second channel state information.

In the following detailed description, detailed features and advantages of the instant disclosure will be described in detail. The content of the detailed description will be sufficient for a person skilled in the art to comprehend and implement the technical content of the instant disclosure. In accordance with the content, claims, and drawings disclosed by the instant disclosure, a person skilled in the art can readily understand relevant goals and advantages of the instant disclosure.

### BRIEF DESCRIPTION OF THE DRAWINGS

The instant disclosure will become more fully understood from the detailed description given herein below for illustration only and therefore not limitative of the instant disclosure, wherein:

FIG. 1 illustrates a schematic diagram of connections between each of the elements in a wireless signal transceiver device according to some embodiments of the instant disclosure;

FIG. 2 illustrates a flow chart of a wireless signal processing method according to some embodiments of the instant disclosure;

FIG. 3 illustrates a schematic diagram of filtering out channel state information sub portions according to some embodiments of the instant disclosure; and

FIG. 4 illustrates a schematic diagram of a processing unit obtaining equivalent frequency-domain information using time-domain information of a time interval according to some embodiments of the instant disclosure.

### DETAILED DESCRIPTION

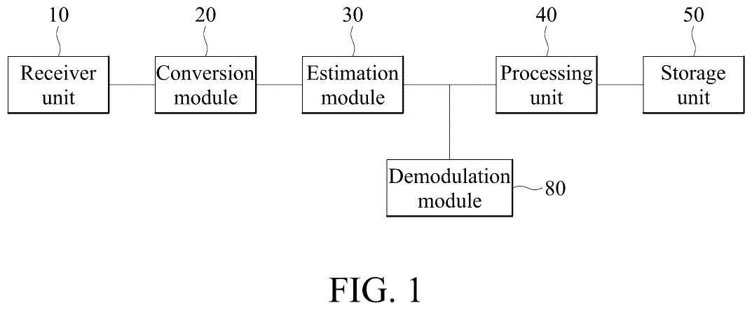

Please refer to FIG. 1. The instant disclosure is related to a wireless signal transceiver device. In one embodiment, the wireless signal transceiver device includes a receiver unit 10, a conversion module 20, an estimation module 30, a processing unit 40, and a storage unit 50. The following paragraphs will introduce the implementation of the foregoing elements.

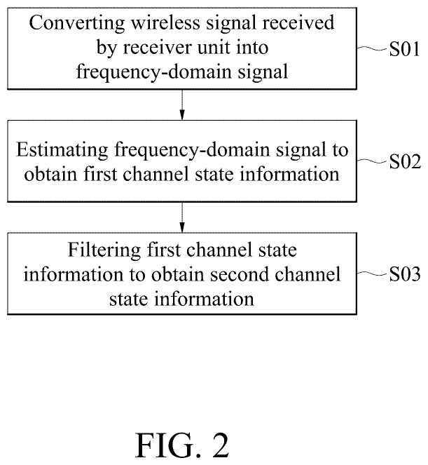

Please refer to FIG. 1 and FIG. 2. The receiver unit 10 is configured to receive a wireless signal. In some embodiments, the receiver unit 10 is a Wi-Fi signal receiver, and the wireless signal is a Wi-Fi signal.

Please refer to FIG. 1 and FIG. 2. The conversion module 20 is electrically connected to the receiver unit 10. The conversion module 20 is configured to convert the wireless signal into a frequency-domain signal (the step S01). In some embodiments, the conversion module 20 converts the wireless signal into the frequency-domain signal using Fourier transform. In some embodiments, specifically, the conversion module 20 is a processor.

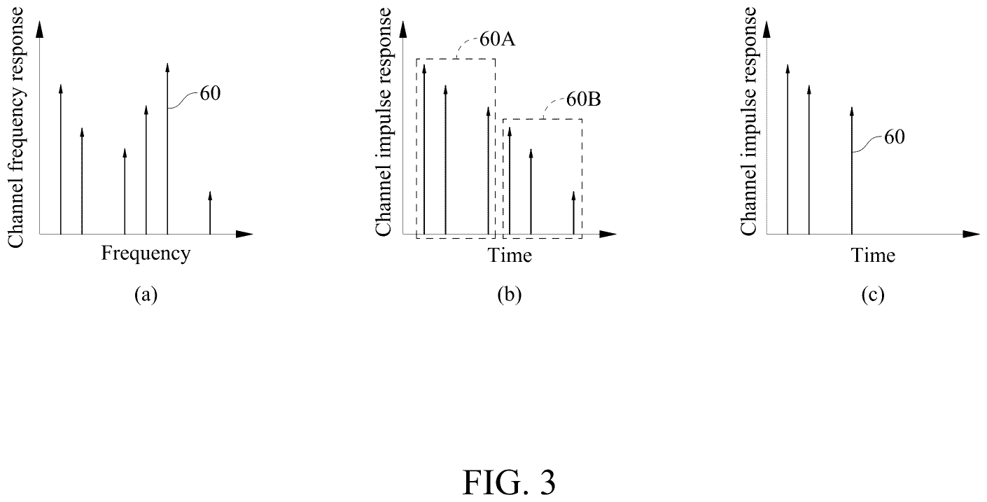

Please refer to FIG. 1, FIG. 2, and FIG. 3(a) through FIG. 3(c). The estimation module 30 is electrically connected to the conversion module 20. The estimation module 30 is configured to estimate the frequency-domain signal so as to obtain first channel state information (CSI). The first channel state information includes a plurality of channel state information sub portions 60 (the step S02). In FIG. 3(a), a frequency and a channel frequency response are used to present an equivalent schematic diagram of the first channel state information in frequency domain. In some embodiments, the estimation module 30 performs channel estimation on the frequency-domain signal using least square (LS) or channel smoothing. In some embodiments, each of the channel state information sub portions 60 is the channel state information of each of the wireless signals which are received by the receiver unit 10 through different paths. In some embodiments, specifically, the estimation module 30 is a processor.

Please refer to FIG. 1, FIG. 2, and FIG. 3(a) through FIG. 3(c). The processing unit 40 is electrically connected to the estimation module 30. The processing unit 40 is configured to filter the first channel state information so as to filter out unnecessary one(s) of the channel state information sub portions 60 and obtain second channel state information (the step S03). In some embodiments, specifically, the processing unit 40 is a processor.

Please refer to FIG. 1. The storage unit 50 is electrically connected to the processing unit 40. After the processing unit 40 obtains the second channel state information, the processing unit 40 stores the second channel state information in the storage unit 50. In some embodiments, the storage unit 50 is a buffer. In some embodiments, the second channel state information which is stored in the storage unit 50 is used for the determination of a physiological state, such as detection of falling, monitoring of breathing, recognition of movement, recognition of user, and positioning.

Please refer to FIG. 1. In some embodiments, the wireless signal transceiver device includes a demodulation module 80. After the estimation module 30 obtains the first channel state information, the estimation module 30 may transmit the first channel state information to the demodulation module 80 and the processing unit 40 respectively. Consequently, the demodulation module 80 can perform demodulation on the first channel state information. Through this process, detailed channel state information can be obtained.

In one or some embodiments, when the channel state information is used to determine environmental changes such as in scenarios of detection of falling, monitoring of breathing, recognition of movement, recognition of user, and positioning, signal transmitting and receiving merely need to obtain information of a detection target within a limited area according to different application scenarios. As a result, the channel state information at an end tail of a channel impulse response (i.e., in the embodiment(s), a channel state information sub portion 60B of the first channel state information, where the channel state information sub portion 60B is outside a time interval) can be ignored. Consequently, the environmental changes can be determined merely in accordance with a channel impulse response within the time interval (i.e., in the embodiment(s), the second channel state information). Therefore, in one or some embodiments of the instant disclosure, the channel state information sub portion 60B (which is a portion of the first channel state information) can be filtered out without converting the first channel state information from time domain to frequency domain. Consequently, when the second channel state information is used to determine the environmental changes, reception of unnecessary information can be reduced, and determination performance can be enhanced.

Please refer to FIG. 3(b) and FIG. 3(c). FIG. 3(b) illustrates a schematic diagram of a scenario where the first channel state information is additionally converted from frequency domain to time domain using IFFT. In this embodiment, the channel state information sub portion 60B (which is outside the time interval) is considered an exterior interference, such as a wireless signal transmitted by another signal transmitter or a wireless signal which has gone through multiple environmental influences (such as reflection) during transmission. Therefore, the channel state information sub portion 60A, which remains after the channel state information sub portion 60B is filtered out, is taken as the second channel state information (as shown in FIG. 3(c)). Next, the conversion between time domain and frequency domain is performed. This process can enhance efficiency when another element performs analysis on the second channel state information. However, a drawback of this method is that the conversion of the channel state information from frequency domain to time domain is needed. Furthermore, after information of external interferences is deleted, the conversion from time domain to frequency domain is performed again. On the contrary, according to one or some embodiments of the instant disclosure, the second channel state information sub portion 60B (which is unnecessary) can be deleted without the condition that the first channel state information has to be converted between time domain and frequency domain. Besides, the second channel state information which is obtained in one or some embodiments of the instant disclosure can be equivalent to the second channel state information (which has been converted between time domain and frequency domain), as shown in FIG. 3(c).

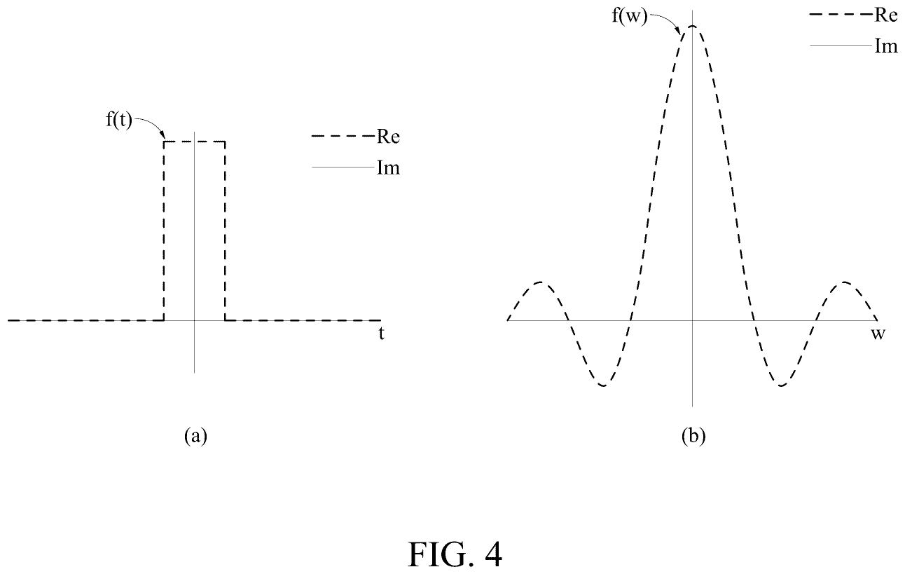

Please refer to FIG. 4(a) and FIG. 4(b). In some embodiments, when the channel state information sub portion 60B (which is outside the time interval) is filtered out from the first channel state information, the processing unit 40 obtains equivalent frequency-domain information f(w) based on time-domain information f(t) of the time interval and then processes the first channel state information using the equivalent frequency-domain information f(w) so as to filter out the interferences. This method is equivalent to a method where the channel state information sub portion 60B (which is outside the time interval) is filtered out from the first channel state information in time domain (as shown in FIG. 3(b)). Thus, the channel state information sub portion 60A is preserved, and therefore the second channel state information (as shown in FIG. 3(c)) is obtained. In FIG. 3(c), the second channel state information is presented in time domain. Accordingly, the first channel state information is not needed to be converted from frequency-domain state to time-domain state. Besides, the channel state information sub portion 60B (which is outside the time interval) is not needed to be filtered out in time domain. Furthermore, a conversion from time domain to frequency domain is not needed additionally. Therefore, the channel state information sub portion 60B (which is outside the time interval) can be directly filtered out from the first channel state information in time domain. As a result, overall processing efficiency of the wireless signal transceiver device is increased, while the effect of interference elimination can be still achieved.

In some embodiments, the manner of obtaining the equivalent frequency-domain information f(w) based on the time-domain information f(t) and filtering out the channel state information sub portion 60B which is outside the time interval for the first channel state information is multiplying the equivalent frequency-domain information f(w) with the first channel state information. In some embodiments, a length of the time interval is dependent on parameters of a filter (such as a smooth filter) selected in accordance with the first channel state information. Alternatively, in some other embodiments, the length of the time interval may be decided in accordance with a range of the space of the detection location.

In some embodiments, physiological status monitoring may be applied to any two wireless internet devices. In this embodiment, the signal receiver end is the receiver unit 10, the wireless internet signal is transmitted through another wireless device, and a human body is between the transmitter unit and the receiver unit 10. Therefore, when the wireless signal passes through the human body, a change in the channel state information will be generated. Therefore, the user can obtain the channel state information reported by the wireless internet device and thus can use the channel state information for detection applications. Accordingly, the physiological state of the human body can be determined in accordance with the channel state information, and therefore physiological state information can be obtained. For example, under the configuration that a human body lies horizontally between the transmitter unit and the receiver unit 10, when the transmitter unit transmits the wireless signal and the wireless signal passed through the human body, the channel state information of the wireless signal will be affected due to the rising and lowering of the chest when the human breathes. As a result, the processing unit 40 performs interference elimination on original channel state information and reports the channel state information to the user (user end). Next, the user analyzes the channel state information to determine a breathing state of the human. In some embodiments, specifically, the transmitter unit is a Wi-Fi signal transmitter.

What is claimed is:

1. A wireless signal transceiver device comprising:
a receiver unit configured to receive a wireless signal;
a conversion module electrically connected to the receiver unit and configured to convert the wireless signal into a frequency-domain signal;
an estimation module electrically connected to the conversion module and configured to estimate the frequency-domain signal so as to obtain first channel state information, wherein the first channel state information comprises a plurality of channel state information sub portions;
a processing unit electrically connected to the estimation module and configured to filter the first channel state information so as to obtain second channel state information; and
a storage unit electrically connected to the processing unit and configured to store the second channel state information.

2. The wireless signal transceiver device according to claim 1, wherein the processing unit filters out the channel state information sub portions which are outside a time interval from the first channel state information so as to obtain the second channel state information.

3. The wireless signal transceiver device according to claim 2, wherein the processing unit obtains equivalent frequency-domain information based on time-domain information of the time interval and then filters out the channel state information sub portions which are outside the time interval from the first channel state information according to the equivalent frequency-domain information.

4. A wireless signal processing method executed by a processing circuit, wherein the wireless processing method comprises:
converting a wireless signal which is received by a receiver unit into a frequency-domain signal;
estimating the frequency-domain signal so as to obtain first channel state information, wherein the first channel state information comprises a plurality of channel state information sub portions; and
filtering the first channel state information so as to obtain second channel state information.

5. The wireless signal processing method according to claim 4, wherein the step of obtaining the second channel state information comprises filtering out the channel state information sub portions which are outside a time interval from the first channel state information so as to obtain the second channel state information.

6. The wireless signal processing method according to claim 5, wherein the step of obtaining the second channel state information comprises obtaining equivalent frequency-domain information based on time-domain information of the time interval and then filtering out the channel state information sub portions which are outside the time interval from the first channel state information according to the equivalent frequency-domain information.
